(19) United States
(12) Patent Application Publication
(10) Pub. No.: US 2023/0182419 A1
(43) Pub. Date: Jun. 15, 2023

(54) TOOL DEVICE FOR MANUFACTURING A RIM, AND RIM, AND USE

(71) Applicant: DT SWISS INC., Grand Junction, CO (US)

(72) Inventor: Andreas Henig, Biel (CH)

(21) Appl. No.: 18/064,463

(22) Filed: Dec. 12, 2022

(30) Foreign Application Priority Data
Dec. 13, 2021 (DE) 10 2021 006 136.5

(51) Int. Cl. B29C 70/86; B29C 70/46; B60B 5/02; B60B 25/02

(52) U.S. Cl. CPC B29C 70/865; B29C 70/462; B60B 5/02; B60B 25/02; B60B 2310/204; B60B 2360/36; B60Y 2200/13; B29L 2031/32

(57) ABSTRACT

A tool device and its use for manufacturing a bicycle rim, having opposite rim flanks, a rim well and a rim base and rim flanges configured on the radially outwardly ends of the rim flanks, wherein the tool device includes two molding devices and a circular device. The circular device forms the rim well and the axially inwardly oriented surfaces of the rim flanges. The circular device includes an annular unit of a less elastic material and at least one cover of a more elastic material. Alternately, the molding devices each include a molding unit of a less elastic material and at least one cover of a more elastic material, for attachment thereto. The thickness of the cover is between one eighth of the minimum wall thickness of the rim well of the rim manufactured and eight times the minimum wall thickness of the rim well of the rim manufactured.

### BACKGROUND

The invention relates to a tool device for manufacturing a rim from a fibrous composite material for vehicles which as a rule are at least partially muscle-powered in use as intended, and, in particular, bicycles, a rim thus manufactured, and use of the tool device for manufacturing.

The prior art has disclosed rims of fiber-reinforced plastics which allow to reduce the weight of the rims. At the same time, given a lower total weight, these rims achieve a stability comparable to, or even higher than, metal rims. A drawback of these rims is, however, the complicated manufacture since many manufacturing steps require mostly manual work, resulting in high costs. Moreover, the many manual process steps are susceptible to errors, which may increase the reject rate, thus further increasing the production costs. On the other hand, high-quality bicycle rims are not produced in large enough quantities so that developing and setting up fully automatic production would pay off.

It has been found that the strength of the manufactured rims does not always meet expectations.

It is therefore the object of the present invention to provide a tool device and its use for manufacturing a rim from a fibrous composite material, which allows manufacturing of rims of a better quality and preferably involving a lower reject rate.

### SUMMARY

The tool device according to the invention provides a rim for at least partially muscle-powered vehicles and, in particular, bicycles, the rim comprising opposite rim flanks, a rim well and a rim base, and rim flanges configured at the (radially outwardly ends of the) rim flanks. The rim flanks (side walls) meet, in particular, in the radially most inwardly point. The tool device comprises two molding devices and one circular device (ring device). The circular device comprises a unit configured as an annular unit, and each of the molding devices comprises a unit configured as a molding unit. The molding devices each comprise contact surfaces for forming at least part of one rim flank each and of the external visible surface of the rim flanges. The circular device configures the rim well and the axially inwardly oriented surfaces of the rim flanges.

At least one of the units of an annular unit and molding units includes a less elastic material and at least one cover for attachment thereto, of a more elastic material. The wall thickness of the cover is, in particular, between one eighth (and preferably one fourth) of the minimum wall thickness of the rim well of the manufactured rim, and eight times (and preferably four times) the minimum wall thickness of the rim well of the manufactured rim. The wall thickness of the cover is preferably between 0.1 mm and 10 mm.

The circular device comprises an annular unit of a less elastic material, and at least one ring cover of a more elastic material. In the alternative or in addition, the molding devices each comprise a molding unit of a less elastic material, and for attachment thereto, at least one mold cover of a more elastic material. This means that either a ring cover is given, or mold covers on the molding units, or both a ring cover on the annular unit and mold covers on the molding units.

The invention has many advantages. A considerable advantage consists in that the rim flanges are formed between the molding devices and the circular device. The circular device comprises the less elastic annular unit and the more elastic ring cover, and/or the molding devices comprise a more elastic mold cover (in particular, in the region of the rim flange). This applies optimal pressure on the rim flange during manufacture. The wall thickness of the cover between ⅛ and 8 times the minimum wall thickness of the rim base provides for reliable function. Wall thicknesses between 0.1 mm and 10 mm for bicycle rims are likewise very advantageous.

The molding units, in particular, also consist of a less elastic material than does the ring cover or the mold cover respectively. This allows the ring cover and/or the mold cover to yield elastically, and to build up and transmit the required pressure to the rim flanges and/or the rim well. The more elastic material of the ring cover and/or the mold cover provides for one, for overload protection, and for another, for sufficient pressure generation. If two very hard and unyielding materials form the space for the rim flange, there may arise—if there is too much material—an overload and thus, displacement of the fibers, and also imperfections on the rim flange. On the other hand, in the case of insufficient material, hollow spaces and air pockets and thus, weakening of the material may result.

The quantity of material is naturally not always ideal. Now the invention enables compensation. If there is (slightly) too much material, the pressure on the rim flange wall is increased, and the more elastic material of the ring cover and/or the mold cover is compressed more forcefully, and in the case of (slightly) too little fibrous composite material, the pressure is (slightly) decreased, and the more elastic material of the ring cover and/or the mold cover is compressed less forcefully. Given specific deviations, both cases allow to exert still sufficient pressure, so that a rim of a high and improved quality can be manufactured.

What is particularly preferred is, to provide either the ring cover or mold covers. Then, a harder material is used on one side, and on the other side, a softer material. It is particularly preferred to use the ring cover, no mold cover. Basically, however, the ring and mold covers can be used together as well.

At any rate, a sufficiently high pressing force can be applied in any spot of the rim. There does not arise any limitation from a firm tool part contacting another firm tool part.

The visual appearance and also the stability under load can be improved. An appropriate compacting can be established in the region of the rim flange. The tool device particularly preferably provides a harder surface on the molding device and a counterpart having a more elastic surface on the ring cover, beneath which a harder surface is in turn present on the annular unit, or reversely. The elastic side expands with the temperature, ensuring good layer bonding between each of the fiber layers in the flange region.

Thus, conceivable (minor) inclusions and defects can be eliminated. Delamination in the flange region due to insufficient compacting can be avoided. The surface quality in the flange region can be improved. Better interlaminar bonding between each of the layers in the flange region and higher mechanical and structural properties can be achieved.

Now, the tool device optimally presses the rim flange. It does no longer occur that two hard tool parts are pressed against each other or pressed on the fiber layers from both sides. At least one of the pressing surfaces is more elastic than the other of the pressing surfaces.

The rim base (rim bottom) and the lower rim flanks (rim sides) are preferably pressed by an inflatable tube or a bladder or a core expanding (with the temperature) against the (in particular, firm) molding units. In these regions, the compacting of each of the fiber layers (e.g. carbon layers and, in particular, prepreg layers) is sufficient.

The rim well is preferably pressed radially outwardly against the circular device and, in particular, the ring cover. It is thus avoided that a firm tool pushes (directly, via fiber layers) against a firm tool in any region. Sufficient pressing can be reliably provided.

Thus, the rims so manufactured can better utilize the feasible potential as regards the mechanical and structural properties and strengths.

In order to provide good compacting in the rim flange region, at least one firm, hard tool part is enveloped in, or replaced by, respectively provided with, an elastic material or a ring cover. This (more) elastic material generates, during the pressing at a temperature, the required pressing force for compacting the flange region.

A considerable advantage is that each region of the rim is pressed. At least one side of the rim wall is pressed by a tool or a medium.

Preferably, the material of the ring cover is configured more elastic than is the material of the molding units, respectively the ring cover is configured more elastic than are the molding units. Then, the molding units provide the exact external shaping of the rim flanks and the rim flanges, and the axially inwardly sides of the rim flanks are compacted with matching flexibility and elasticity.

Preferably, the circular device (and, in particular, the annular unit) comprises a plurality of circumferentially composed annular segments. The circular device preferably comprises, in the radially inwardly region, a contact surface for forming the rim well. The contact surface for forming the rim well may be configured immediately on the annular unit. It is possible and preferred for the ring cover to form or provide the contact surface for forming the rim well. The ring cover may be configured circumferential as one piece, or may consist of two or more segments.

The tool device is very advantageous and provides the option of manufacturing high-quality, reproducible rims, in particular, for bicycles.

In preferred configurations, the ring cover comprises at least one (elastic or more elastic) pressing ring, which is, in particular, matched to the inner outline of the rim flange respectively rim flanges. Preferably, the circular device comprises two separate, axially spaced-apart (elastic) (circumferential) pressing rings. Alternately, the ring cover may extend continuously from one rim flange to the other rim flange, so that only one pressing ring is provided, which covers the internal surfaces of both of the rim flanges and of the rim well.

Preferably, the ratio of the coefficients of elasticity of the materials of the annular unit (molding unit) and of the ring cover (mold cover) is higher than 2 or higher than 5. The ratio of the coefficients of elasticity may be as high as, and may exceed, 10, 20 or 50 or 100 or 1000 or 5000 or 10000. Preferably, the coefficient of elasticity respectively the modulus of elasticity of the ring cover (mold cover) is less than 5 or 1 or 0.1 GPa. The modulus of elasticity of the annular unit and/or the modulus of elasticity of the molding units is preferably higher than 5 or 10 or 25 or 50 GPa. The modulus of elasticity of the ring cover preferably lies between 0.1 MPa and 5 GPa (between 0.1 and 5000 megapascal) and, in particular, between 0.3 and 30 MPa.

Preferably, the ring cover and the mold cover consist at least partially of a material taken from a group of materials comprising rubber-like materials and silicone materials.

The annular unit, in particular, consists, at least predominantly, of at least one metallic material, and the annular unit particularly preferably consists (substantially or completely) of a light metal. Preferably, the annular unit forms a core (of a more rigid or) less elastic material than the ring cover. The ring cover is preferably more elastic than the annular unit.

At least part of the ring cover and/or the mold covers, in particular, consist of a rubber elastic or elastomeric material. Particularly preferably, the ring cover and/or the mold covers consist at least partially, or substantially, or nearly completely, or completely, of a silicone. Using silicone elastomerics, polyurethanes, and/or at least one silicone rubber is possible.

It is preferred for the thickness (wall thickness) of the ring cover and/or the mold covers to be larger than 0.5 mm and/or less than 5 or 7 mm. The wall thickness in the radially central region of the rim flange lies, in particular, between 1 mm and 5 mm, and it may be e.g. 3 mm or 4 mm. A minimum wall thickness provides for an elastically compressible equalizing volume. A maximum wall thickness ensures precise shaping of the component.

Alternately, the thickness of the ring cover and/or the mold covers may be dependent on the coefficient of elasticity (modulus of elasticity). Given a lower coefficient of elasticity and thus a more elastic ring cover respectively mold covers, the wall thickness of the cover is preferably selected thinner than given a higher coefficient of elasticity of the ring cover respectively the mold covers. The product of the coefficient of elasticity of the ring cover/mold covers and the wall thickness may be a measure (for assessment). Given higher elasticity, the wall thickness is reduced, and vice versa. The wall thickness used may be the wall thickness e.g. in a typical region of the ring cover or e.g. in the radially central region of the rim flange or of the rim well. Compliance with the predetermined shape is a significant aspect. Deviations of the wall thickness in the finished rim of more than 10% (or 5%) are undesirable as a rule.

What is particularly preferred is a thickness of the ring cover and/or mold covers is larger respectively greater than half the axial wall thickness respectively width of the rim flange (in a radially central region) and/or thinner than three times or five times the axial wall thickness respectively width of the rim flange. The wall thickness (thickness) of the ring cover and/or the mold covers is, in particular, at least (approximately) the axial width of the rim flange (in a central region) and/or is less than three times or twice the axial width (wall thickness) of the rim flange.

The same annular unit may be employed for manufacturing two rims in different dimensions, by means of different ring covers. For example, with the axial width differing only by 1 mm or 2 mm, another ring cover of a somewhat larger wall thickness may be selected. Optionally, a disk ring is inserted for equalizing the width, or a different center part of the annular unit with a matching width is used.

Particularly preferably, the molding units and (and/or) the circular device consist of (at least) one light metal, and (and/or) they are, in particular, manufactured and/or finished by chip removal. The contact surfaces of the molding units and/or their units with the manufactured rim are preferably polished. Once again this increases the quality of the manufactured rim.

The tool device, in particular, comprises at least one auxiliary molding part, which, together with one of the ring devices, forms a mold surface for forming out the rim base. It is also possible to provide one auxiliary molding part for each of the two molding devices. Then, one of the molding devices may optionally be used with the matching auxiliary molding part.

It is possible and preferred for the molding devices and/or the circular device and/or the auxiliary molding part to show alignment units corresponding to one another. This reproducibly provides alignment of each of the molding devices with the circular device, respectively with the auxiliary molding part, to one another. For attaching the molding devices and the circular device respectively the auxiliary molding part to one another, appropriate fasteners are, in particular, provided, which can be mounted to corresponding attachment openings or to the alignment units. For example, screws, pegs, rivets, clamps or detent mechanisms or the like can be used for fasteners.

In all the configurations, it is preferred for each of the molding devices and the circular device to have a weight of less than 35 kilos and, in particular, less than 30 kilos or less than 25 kilos and particularly preferably, less than 20 kilos or 15 kilos. At least one molding device, in particular, has a weight of less than 15 or less than 12 or less than 10 kg. When assembled, the two molding devices and the circular device preferably have a total weight of less than 35 kilos or less than 30 kilos or even less than 20 kilos. This permits one person to move each of the units and the entire tool device alone, and without requiring the help of another person. This facilitates the manufacture.

The fact that the tool device comprises compact molding devices and a compact circular unit, which parts are manufactured by turning or milling, quite considerably reduces the manufacturing costs for a tool device. A larger quantity of tool devices can be employed for production in parallel. Rims can be manufactured in a higher quality, generating lower costs, and moreover requiring minor refinishing of the visible surfaces or none at all.

Use according to the invention is implemented by employing a tool device. The tool device is used for manufacturing a rim for at least partially muscle-powered vehicles and, in particular, bicycles, wherein the tool device is configured as described above.

The applicant reserves the right to claim a method. The method according to the application manufactures a rim from a fibrous composite material having opposite rim flanks, a rim well and a rim base, and rim flanges configured at the (radially outwardly ends of the) rim flanks for vehicles at least partially muscle-powered (in typical operation as intended), and, in particular, bicycles, and is implemented using a tool device as described above. The tool device comprises two molding devices, for example a left-side molding device and a right-side molding device. The tool device furthermore comprises a circular device.

The method is carried out by way of the following process steps in this or another useful sequence:
One molding device of the two molding devices is selected and provided. The molding device comprises a flank contact surface for forming a lateral (and for example the left-side or the right-side) rim flank.
(At least) one first fiber layer of the at least one fibrous composite material is applied to the flank contact surface of the selected molding device, which forms the visible layer of at least the greater part of the visible surface, and, in particular, nearly the entire, or the entire, visible surface of the pertaining (for example the left-side) rim flank.
The other of the molding devices is provided, which comprises a flank contact surface for forming the other (and opposite) lateral rim flank. This rim flank may for example form the right-side rim flank or in reverse, correspondingly form the left-side rim flank.
(At least) one first fiber layer of the at least one fibrous composite material is applied to the flank contact surface of the other of the molding devices, which, as a visible layer, forms at least the greater part of the visible surface, and, in particular, nearly the entire, or the entire, visible surface of the other rim flank.
A plurality of annular segments is connected to form an annular unit and provided with at least one ring cover, so as to create a circular device with a (radially inwardly) circumferential rim well contact surface and contact surfaces for the rim flanges, wherein at least one first fiber layer of the fibrous composite material is applied, forming the rim well.
The circular device is placed against one of the molding devices (for example the left-side or the right-side molding device). The other molding device (the corresponding, right-side or left-side molding device) is placed against it, and the circular device and the molding devices are connected with one another.
The fibrous composite material is allowed to set and, in particular, hardened, and the annular segments and the molding devices are removed, and the rim is taken out.

Another, modified method according to the application of manufacturing a rim having opposite rim flanks, a rim well and a rim base, and rim flanges configured at the rim flanks from a fibrous composite material for at least partially muscle-powered vehicles and, in particular, bicycles, is implemented by employing a tool device with two molding devices, e.g. a left-side molding device and a right-side molding device, and with a circular device. The molding devices comprise, in particular, a molding unit and a mold cover each. The following method steps are carried out in this or another useful sequence:
One molding device of the two molding devices is selected and provided. A mold cover is applied thereon, so as to provide a molding device with a flank contact surface to form a lateral rim flank.
(At least) one first fiber layer of the at least one fibrous composite material is applied to the flank contact surface of the selected molding device, which forms the visible layer of at least the greater part of the visible surface, and, in particular, nearly the entire, or the entire, visible surface of the pertaining (for example the left-side) rim flank.
The other of the molding devices is provided, and a mold cover is applied thereon, so as to provide the other molding device with a flank contact surface to form the other (and opposite) lateral rim flank. This rim flank may for example form the right-side rim flank or in reverse, correspondingly form the left-side rim flank.
(At least) one first fiber layer of the at least one fibrous composite material is applied to the flank contact surface of the other of the molding devices, which, as a visible layer, forms at least the greater part of the visible surface, and, in particular, nearly the entire, or the entire, visible surface of the other rim flank.
A plurality of annular segments is connected to form a circular device (and optionally provided with at least one ring cover), so as to create a circular device with a (radially inwardly) circumferential rim well contact surface and contact surfaces for the rim flanges, wherein at least one first fiber layer of the fibrous composite material is applied, forming the rim well.
The circular device is placed against one of the molding devices (for example the left-side or the right-side molding device). The other molding device (the corresponding, right-side or left-side molding device) is placed against it, and the circular device and the molding devices are connected with one another.
The fibrous composite material is allowed to set and, in particular, hardened, and the annular segments and the molding devices are removed, and the rim is taken out.

The rim is thus substantially completed (according to the different variants which can be combined with one another). Thereafter, spoke holes if any may be made.

The method, in particular, provides for making the cover (mold cover, ring cover) with a wall thickness that is, in particular, between one eighth of the minimum wall thickness of the rim base and/or the rim flange, and eight times of the minimum wall thickness of the rim base and/or the rim flange.

The method according to the application has many advantages. A considerable advantage of the method according to the invention is that the visible surfaces which in operation as intended are external, are (directly) shaped and formed by the molding devices, on which first fiber layers are applied. The rim flanges are formed between (the ring cover of) the circular device and (the mold covers of) the molding devices. At least one of the contact surfaces of the rim flange is configured more elastic. This provides a homogeneous, reproducible full-surface placement of the fiber layers on the molding devices of the tool device.

The surface quality of the rim flanks can be considerably improved due to the fact that the entire visible outer surface of the finished rim ensues by way of surfaces directly resting against the molding devices of the tool device. The quantity of air pockets and other defects can be significantly reduced, so as to enable noticeable reduction of the reject rate. The process is less susceptible to errors. A fiber distortion in the fiber layers may also be reduced and largely prevented, so that the quality and stability of the rim thus manufactured is increased. The position and orientation of the fibers in the outer fiber layers is defined at all times, thus improving the stability and the visual appearance.

The improved visual appearance of the manufactured rim thus provides the opportunity to manufacture the rim “out of the mold”. The clearly defined shape and position of the fiber layers and the fibers contained therein allow to greatly reduce flaws in the hardened rim.

In contrast to this, the prior art discloses methods wherein fiber layers are firstly inserted in an auxiliary tool. A bundle of fiber layers thus premolded is then transferred to, and inserted in, the tool proper. During transfer of the fiber layers, some fibers and fiber layers may be displaced, so that the position and shape of each of the fiber layers is not always reproducible. However, thus far the method has been carried out in this way among other things since the tool proper is so heavy that it cannot readily be transported manually by one person (or several persons). With the invention, however, one single person can readily transport each of the parts of the tool device separately. This is why at any rate the visible layers and also the reinforcement layers can be directly placed in the mold.

Preferably, the fiber layers are inserted in the tool units, and the outer layers visible on the finished rim are pressed directly against the tool units. Preferably, each of the molding devices form the entire visible region of the rim flanks. The circular device preferably forms the visible region of the rim well.

In a preferred specific embodiment, the fiber layers are pressed against the molding devices of the tool device, to ensure full-surface contact between the fiber layers and the flank contact surfaces. This avoids air pockets and flaws, and thus to enhance the quality.

In particularly preferred specific embodiments, all the fiber layers, which in use as intended, as visible layers, form the visible outer surfaces, are pressed against the molding devices and the circular device of the tool device, to ensure full-surface contact between the fiber layers and the flank contact surfaces. This improves the structure and the quality.

Refinishing work to the visible surface and, in particular, re-varnishing the outer surface to cover up air pockets and other flaws can be avoided. This results in a particularly advantageous method. The fact that the visible surfaces do not require any re-varnishing, saves another method step, thus reducing the costs. It is another considerable advantage that the total weight of the rim is reduced since the weight of a layer is omitted.

In particularly advantageous configurations, an auxiliary molding part of the tool device is used. An auxiliary molding part of the tool device matching the selected molding device is connected with the previously selected molding device, so that the (selected) molding device together with the auxiliary molding part forms a (shared) mold surface for the rim base circling the axis of symmetry of the rim. The mold surface for the rim base is configured in sections on the selected molding device and in sections, on the auxiliary molding part.

In this configuration, the first fiber layer is not only applied to the flank contact surface of the selected molding device, but the first fiber layer is (integrally) also applied to the rim base region of the auxiliary molding part, so as to form a continuous first fiber layer in the region of the rim base. This continuous first fiber layer does not only extend over the rim base region of the (selected) molding device, but also over the rim base region or rim base mold region of the auxiliary molding part. Thus, the first fiber layer is preferably continuously applied to the flank contact surface of the selected molding device and to the rim base region of the auxiliary molding part, so as to provide a continuous and integral first fiber layer in the region of the rim base. These specific embodiments allow to manufacture a particularly robust and high-quality rim.

In preferred specific embodiments, the auxiliary molding part is then removed from the selected molding device, and (immediately thereafter or preferably later) the two molding devices covered with fiber layers are connected with one another. For removing the auxiliary molding part, particular care is taken so that the draped fiber layers in the region of the rim base retain their shape (approximately or at least substantially). The sections of the fiber layers protruding from the selected molding device in the region of the rim base, together with the fiber layers placed on the other of the molding devices, form the other of the rim flanks. The “protruding” sections, however, do not form a visible surface on the finished rim.

It is preferred that after removing the auxiliary molding part, the circular device is placed first, and thereafter, the other molding device is placed.

In simple configurations, the selected molding device is placed on a table which is for example horizontal, for laying fiber layers, and the first fiber layer and optionally further fiber layers are placed on the flank contact surface of the selected molding device and optionally on the auxiliary molding part, and pressed against the pertaining contact surfaces. In parallel or thereafter or before, the other of the molding devices is for example placed on an e.g. horizontal table, and a first fiber layer is laid on the other of the molding devices, and optionally, further fiber layers are placed on the other of the molding devices.

The circular device may be covered with the fiber layers in parallel or before or after. After removing the auxiliary molding part, the circular device is placed on the selected molding device with the fiber layers placed on the rim well contact surface. Thereafter, the other of the molding devices with the placed fiber layers may be placed on the selected molding device and the circular device. Given this configuration, each of the molding devices is placed step by step on a horizontal table. Alternately it is possible for the table to be disposed at an angle to the horizontal, or for the molding devices to be positioned vertically in the space, and for the fiber layers to be pressed against the pertaining molding devices from the side.

In preferred specific embodiments, the first fiber layer placed on the selected molding device forms the visible layer with the visible surface of the pertaining rim flank in the region of the flank contact surface, and in the rim base region of the auxiliary molding part, a reinforcement layer of the rim base, but not the visible layer with the visible surface of the other of the rim flanks. This achieves an advantageous connection of the two halves. The two halves of the rim may be configured symmetrically or asymmetrically.

Preferably, the visible rim base is formed by the radially inwardly regions of the rim flanks, respectively by the radially inwardly regions of the first fiber layers which are placed on the selected molding device respectively the other of the molding devices.

In advantageous configurations, the two molding devices and the auxiliary molding part each show a mold parting surface running perpendicular to the axis of symmetry of the rim. Each of the molding devices and the auxiliary molding part can be selectively placed against one another at the mold parting surface. Thus, the auxiliary molding part is preferably first placed against the selected molding device, and removed after placement of the appropriate fiber layers. Thereafter, the other of the molding devices with the pertaining mold parting surface is placed against the mold parting surface of the selected molding device.

Preferably, at least one reinforcement layer is inserted in the interconnected molding devices (at least in the region of the rim base).

What is particularly preferred is a sequence of method steps wherein the auxiliary molding part is placed on the selected molding device, the auxiliary molding part is removed after placing first fiber layers, and the circular device with the fiber layers previously placed thereon, is placed. Finally, the other of the molding devices with the fiber layers placed thereon is placed.

In all the configurations, rim flanges are configured on the two rim flanks. In particular, at least one rim flange is at least partially formed by fiber layers, which are placed on one of the molding devices and on the circular device. This means that a rim flange is preferably formed both by fiber layers placed on a molding device, and also by fiber layers placed on the circular device. This increases stability.

In advantageous specific embodiments, at least one roving is inserted for reinforcement in the region where the rim well intersects the rim flank. This roving may consist of a plurality of filaments, or of a bundle of filaments, or may comprise filaments. Alternately it is possible to use for rovings, for example braided filaments or corded or twisted filaments. These inserted rovings can reinforce the crossing regions between the rim well and the rim flank and the rim flange.

In all the configurations it is preferred for the circular device to comprise, in the peripheral direction, at least two and, in particular, three or more annular segments. Particularly preferably, there are three annular segments in the peripheral direction. It is also possible to use two annular segments only, extending over an angle of 180° each. Preferably, three annular segments are used, so that each of the annular segments extends over an angle at circumference of clearly less than 180°. Preferably, the annular segments are configured identically, so that in the case of three annular segments, each preferably covers an angular range of 120°. It is also conceivable for each of the annular segments to extend over different angular ranges. The annular segments all together extend over the entire circumference.

Preferably, the circular device comprises, in the axial direction (parallel to the axis of symmetry of the rim) transverse to the peripheral direction, at least two and, in particular, three or more annular segments. It is thus possible for the circular device to consist of nine annular segments in total. Each three annular segments together form a ring. The three rings (having three annular segments each) are disposed sequentially in the axial direction. The annular segments may be disposed at an offset in the axial direction. The annular segments in total form the circular device, which radially inwardly forms the rim well contact surface.

The axially central annular segments may, in particular, be configured in a wedge shape. This allows first removal of the central annular segments after manufacture. Thereafter, the other annular segments may be removed, which for example form an undercut on the rim flanges, to provide radially inwardly protruding ends of the rim flanges.

Alternately it is conceivable for the axially central annular segments all together to form a disk-shaped ring instead of a wedge shape. Also in this case, the axially outwardly annular segments may form an undercut on the rim flanges.

In advantageous configurations, a locking ring is provided, which is placed outwardly around the interconnected molding devices and the circular device. The locking ring may be placed radially from the outside, reinforcing the coherence between the components. In this respect, the locking ring may be referred to as an external clamping ring. It is also possible to omit a locking ring, in particular, if the molding devices and the circular device can be interconnected in another way.

Preferably, the tool device loaded with the fiber layers is evacuated prior to hardening. Particularly preferably, the tool device is inserted into a pressure device and/or heated. This can aid in the setting or hardening of the fibrous composite material.

In all the configurations, it is particularly preferred to use fiber layers impregnated with at least one resin. These fiber layers provided or impregnated with matrix material (in particular, resin) may also be referred to as prepregs, and may preferably contain a quantity of matrix material (and preferably of resin) that is (at least substantially) sufficient for hardening. The use of prepregs is particularly advantageous. It is also conceivable to (additionally) insert matrix material or resin material into the completely loaded tool device. For example, matrix material or resin material may be injected or aspirated. It is also possible to use for prepregs, fiber layers, fiber mats, woven mats or the like, and to additionally insert (some) resin material.

In all the configurations, it is preferred to insert an inflatable tube (into the region of what is to be the hollow space), before connecting the molding devices with the circular device. Preferably, the tube is inflated after fastening the molding devices to the circular device. An outwardly connection for inflating for example forms the valve opening intended for later. This allows subsequent removal of the tube.

It is preferred to insert spoke holes after removing the rim from the tool device.

A rim according to the invention for at least partially muscle-powered vehicles and, in particular, bicycles comprises opposite rim flanks, a rim well and a rim base, and rim flanges configured at the (radially outwardly ends of the) rim flanks. The rim flanks meet, in particular, in the radially most inwardly point. The rim is manufactured of at least one fibrous composite material by means of a method as described above, employing a tool device as described above. In a preferred specific embodiment, the outermost surface visible in operation as intended, consists at least predominantly or completely of the at least one fibrous composite material. This is true, apart from any rim eyelets and model designations, and e.g. stickers which are small compared to the rim surface, wherein the factor of the surface for example of stickers to the rim surface is less than ⅕ or 1/10 or 1/100.

The rim according to the invention is very advantageous and provides a high surface quality and a reproducible, high quality, even without finishing the outside surface, and, in particular, without varnishing the outside surface.

In all the configurations, a rim manufactured with the tool device and/or the method described is, in particular, provided for wheels equipped with a disk brake, and it does, in particular, not need a brake flank.

The rim is, in particular, configured convex. The rim may show a V- or U-shape. Preferably, the widest spot of the rim lies between the radially outwardly end of the rim (at the rim flanges) and a radially inwardly end, at the rim well. To this end, the tool device is preferably configured correspondingly convex.

Further advantages and features of the present invention can be taken from the exemplary embodiments which will be discussed below with reference to the enclosed figures.

### BRIEF DESCRIPTION OF THE DRAWINGS

The figures show in:

FIG. 1 a schematic illustration of a mountain bike with rims according to the application;

FIG. 2 a schematic illustration of a racing bicycle with rims according to the application;

FIG. 3 a schematic total view of a tool device according to the application for manufacturing a rim according to the application;

FIG. 4 an exploded view of the different components of the tool device according to FIG. 3;

FIG. 5 a molding device and an auxiliary molding part of the tool device according to FIG. 4;

FIG. 6 two sectional views of the tool device while manufacturing a rim;

FIG. 7 a finished rim according to the application;

FIG. 8 sectional views of the tool device and of the fiber layers of a rim while implementing the method according to the application;

FIGS. 9-12 different sectional views while manufacturing rims according to the application; and

FIG. 13 a schematic plan view of the circular device of the tool device according to FIG. 3.

### DETAILED DESCRIPTION

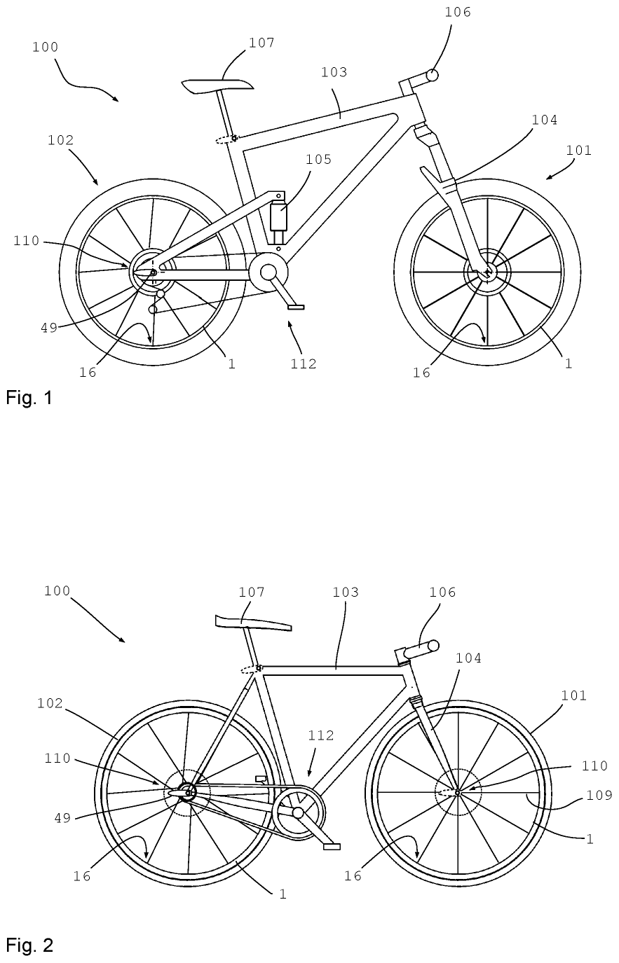

The FIGS. 1 and 2 each show a mountain bike respectively racing bicycle 100, each equipped with rims 1 according to the application. The mountain bike respectively racing bicycle 100 is provided with a front wheel 101 and a rear wheel 102, where rims 1 according to the application are employed. The two wheels 101, 102 are provided with spokes 109 connecting the rim 1 with the hubs 110. To this end, the rim 1 is provided with spoke holes 16.

A bicycle 100 comprises a frame 103, a handlebar 106, a saddle 107, a fork or suspension fork 104 and in the case of the mountain bike, a rear wheel damper 105 may be provided. A pedal crank 112 with pedals serves for driving. Optionally, an electric auxiliary drive may be provided on the pedal crank 112 and/or the wheels. The hubs 110 of the wheels may be attached to the frame by means of a clamping system 49 (for example a through axle or a quick release).

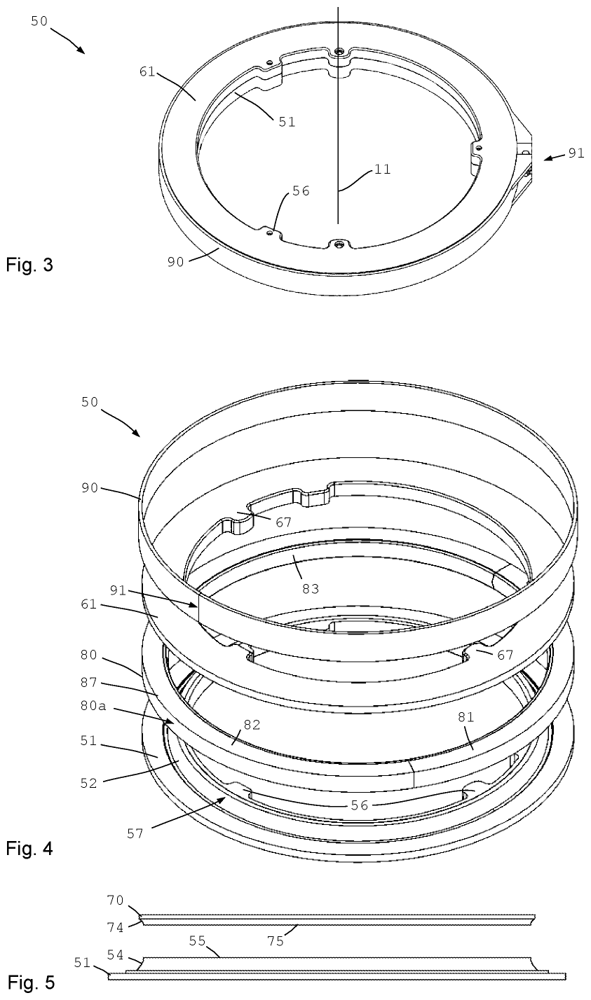

FIG. 3 shows the tool device 50 in the assembled state with the fiber layers already inserted to manufacture the rim 1, prior to inserting the tool device 50 into a separate pressure device, in which the tool device 50 is also heated to accelerate the hardening of the fibrous composite material. The tool device 50 is substantially configured rotationally symmetrical around an axis of symmetry 11, which at any rate forms an axis of symmetry for the finished rim 1.

FIG. 4 shows an exploded view of the tool device 50, at the top of which a locking ring 90 is illustrated that is provided with a clamping portion 91 and a screw, not visible. The locking ring 90 may be placed around the further components of the tool device 50, and may serve as a clamping ring. Optionally, this locking ring 90 may be omitted.

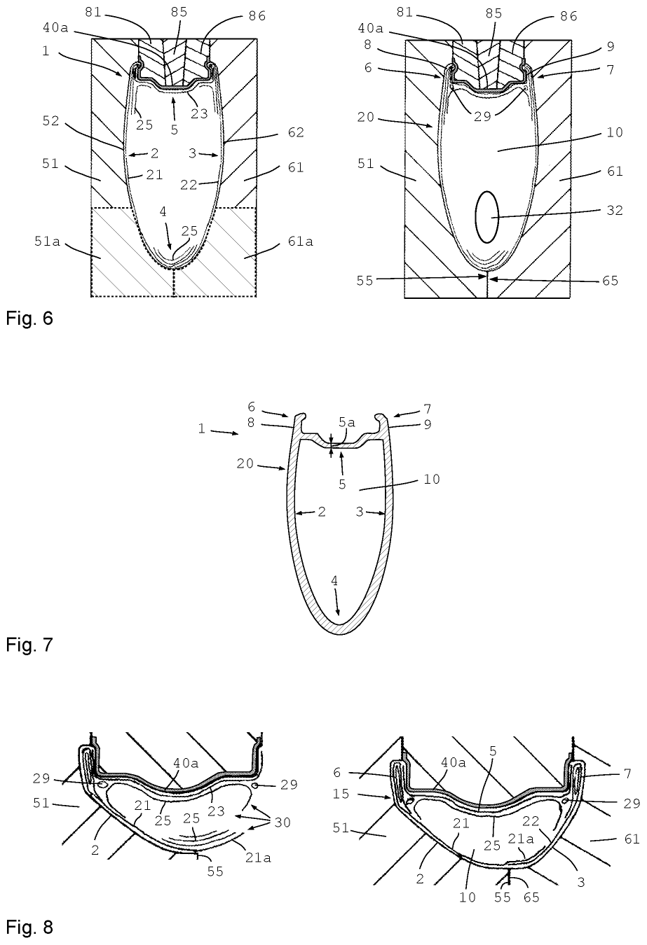

The bottommost component illustrated is a molding device 51, including a flank contact surface 52 (side wall contact surface) which serves to form one of the two rim flanks of the rim 1 manufactured. The molding device 51 shows fasteners 56 and configured or disposed thereat, alignment units 57, to which the molding device 51 with the circular device 80 and the other of the molding devices 61 is fastened by means of appropriate fasteners 56, or to the alignment units 57. The circular device 80 comprises an annular unit 80a (forming a core 80a) and, in particular, a ring cover 40a (see FIG. 6), and comprises alignment units 87. The other of the molding devices 61 also comprises alignment units 67. Each of the two molding devices 51, 61 may consist of a molding unit 51a, 61a (core) and a mold cover 51b, 61b (see FIG. 11).

As can be seen in FIG. 4, the annular unit 80a of the circular device 80 or ring device 80 consists of a number of annular segments 81-83 extending in the peripheral direction around the central axis of symmetry 11. This allows separate removal of the annular segments.

FIG. 5 shows a molding device 51 and the pertaining auxiliary molding part 70, which are interconnected to cover the flank contact surface 72 and the rim base regions 54 and 74 with fiber layers of the fibrous composite material. In this way, the region of the rim base is reinforced by one joint, continuous layer.

The molding device 61 and the auxiliary molding part 70 are interconnected with, respectively placed on top of, one another on the mold parting surfaces 55 and 75 (contact areas).

FIG. 6 shows two schematic illustrations of the tool device 50 and fiber layers 21-23 and 25 disposed therein. In the assembled state, the tool device substantially consists of a first molding device 51, a second molding device 61, and the circular device 80, which in turn comprises an annular unit 80a with a number of annular segments 81-83 (in the peripheral direction) (see FIG. 4) and (in the axial direction) annular segments 85, 86 and a ring cover 40a (ring cover unit 40a).

The ring cover 40a consists of a more elastic material than does the annular unit 80a (core of 80) and the molding devices 51, 61 or their molding units 51a, 61a (core of 51, 61). In this way, during hardening in the tool device 50, the regions of the rim flanges are pressed to the molding devices 51, 61 respectively the annular unit 80a, on one side by a more elastic material (ring cover 40a) and on the other side, by a less elastic material. Due to the heat generation during hardening and the thermal expansion, the pressure is further increased. The ring cover 40a consists, in particular, of a rubber material or rubber-like material, or preferably of a silicone or the like, or of a combination. The annular unit 80a and the molding devices 51, 61 are preferably manufactured of metal and, in particular, light metal.

Here, the ring cover 40a also covers the region of the rim well 5 on which pressure is applied from inside during hardening by way of the (inflatable) tube 32. The ring cover 40a acts against it from outside.

Optionally, the molding devices 51 and 61 may be configured multipart and may for example additionally comprise molding units (molding cores) 51a and 61a. Preferably, however, each of the molding devices 51 and 61 is configured as one piece (each forming a core), wherein separate mold covers 51b, 61b may be optionally provided (see FIG. 11). The molding device 51 shows a flank contact surface 52 for the rim flank 2 on the left, while the rim flank 3 on the right is formed by a (side wall) flank contact surface 62. The flank contact surfaces 52 respectively 62 are covered with fiber layers 21 respectively 22. Reinforcement layers 25 are also applied in the region of the rim base 4. The rim well 5 is formed by at least one fiber layer 23, which is applied radially inwardly on the circular device 80.

The two rims 1 illustrated in FIG. 6 are each provided with rim flanges 6, 7, which are configured by fiber layers 21, 23 and 25. The outer surfaces 8 and 9 of the two rim flanks 2, 3, which will later be visible from the outside, are each formed by the first fiber layer 21 placed on the flank contact surface 52 and by the first fiber layer 22 placed on the flank contact surface 62. The visual range of the rim well is formed by the first fiber layer 23 placed on the circular device 80. In the closed tool device, the elastic ring cover 40a applies pressure on the rim flanges.

All the visible surfaces respectively all the visible layers of the finished rim 1 are thus provided by the fiber layers 21-23, each of which is applied separately and full-surface on the molding devices 51 and 61, and the ring cover 40a of the circular device 80. This achieves a particularly high surface quality, since air pockets or other flaws can be avoided better than in the prior art.

To allow to apply pressure from the inside during hardening, a tube 32 (shown schematically only) is as a rule inserted, which can be guided outwardly through what is intended as the valve opening, and on which pressure can be applied after closing the tool device 50, to press each of the fiber layers 21-25 from the inside against the inner walls of the tool device 50. This secures a reliable composite. The tube 32 may be configured elastically, expanding when inflated. It is likewise possible and preferred for the tube 32 to be of sufficient size or matching configuration and with insertion, to be placed full-surface on at least one flank contact surface, and radially from the inside, placed full-surface on the circular device.

Optionally it is possible, as can be seen on the right in FIG. 6, to insert peripheral rovings or fiber bundles 29 in the intersection of the rim flank 2, 3 with the rim well 5, to reinforce those regions and configure them still more robust.

FIG. 7 shows a schematic illustration of a finished rim 1, comprising a rim base 4, a rim well 5, and rim flanks 2, 3, on which rim flanges 6, 7 are configured. A hollow space or hollow section 10 can be seen in the interior. The rim 1 is manufactured by way of a method according to the application and a tool device according to the application, of at least one fibrous composite material. FIG. 7 also shows the minimum wall thickness 5a of the rim base 5.

FIG. 8 shows two schematic illustrations during manufacture. What is shown is, simplistic illustrations of the fiber layers in a tool device 50, wherein the outlines and the positions of the fiber layers 21-23 and 25 are shown intentionally roughly to give an illustrative example of the outlines of each of the fiber layers. In the illustration on the right in FIG. 8 it can be seen that the fiber layer 21 was not only placed onto the flank contact surface 52 of the molding device 51, but also onto the rim base region 74 of the auxiliary molding part 70, to form a reinforcement section 21a in the region of the rim well contact surface 62 of the other of the molding devices 61. Thus, an overlap of each of the fiber layers is enabled from one of the rim flanks to the other of the rim flanks in the region of the rim base.

Circumferential rovings 29 are schematically shown, in the intersecting region 15 of the rim flanges 6, 7 with the rim well 5 respectively the rim flanks 2, 3 or side walls.

In the lower region, the mold parting surfaces 55 and 65 (contact areas) of the two molding devices 51 and 61 can be seen, where the two molding devices 51 and 61 are joined together.

FIG. 8 shows on the left, a pre-stage during manufacture of the rim 1 illustrated further to the right. FIG. 8 illustrates on the left, the state after connecting the selected molding device 51 with the auxiliary molding part 70, and placing fiber layers 21 and reinforcement layers 25 thereon, and after removing the auxiliary molding part 70, and placing the circular device 80 with the annular unit 80a and the ring cover 40a on the selected molding device 51.

This results in the layer structure visible on the left in FIG. 8, wherein due to the inherent stiffness of the prepregs 30 used (for fiber layers 21-23 and 25), the protruding reinforcement section 21a and the correspondingly protruding regions of the fiber layers 25 (substantially) retain their shape. Thereafter, the other of the molding devices 61 can be placed onto the (selected) molding device 51 and the circular device 80, so that on the whole, a closed rim profile results for the rim 1. Then, in the region of the rim flange 7, the fiber layer 22 placed on the molding device 61 is pressed against the fiber layer 23 on the ring cover 40a of the circular device 80. In the region of the rim base, the fiber layer 22 is pressed against the reinforcement section 21. Then, the tube 32 in the interior of the hollow space 10 of the rim 1 inflated in the further process, presses all of the layers reliably against one another and outwardly against the molding devices 51 and 62 and the ring cover 40a of the circular device 80.

The outer surfaces of the finished rim, which are particularly significant for the visual effect, are configured in a high quality, since what are the outside fiber layers 21, 22 and 23 forming the visible layers of the finished rim 1, are each separately pressed full-surface against the corresponding contact surfaces (flank contact surfaces 52, 62 and rim well contact surface 84). The rim flanges 6, 7 are manufactured in a particularly high quality, since the ring cover 40a provides for a suitable pressure.

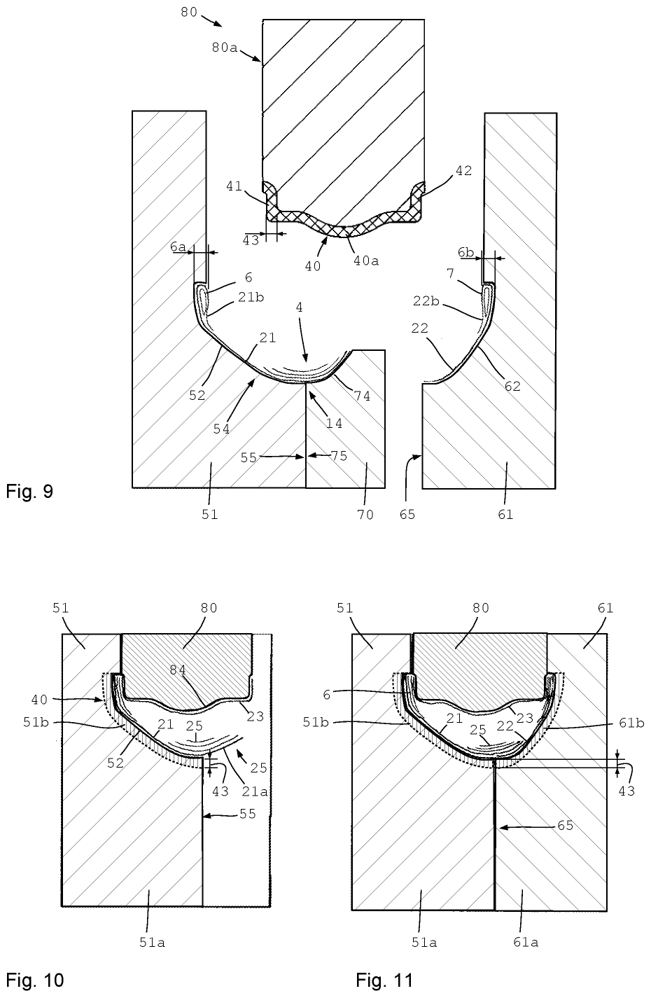

FIG. 9 shows the state during manufacture of a rim 1, after placing a first fiber layer 21 onto the rim contact surface 52 of the selected molding device 51 and the rim base region 74 of the auxiliary molding part 70. Furthermore, reinforcement layers 25 have been placed, contacting the mold surface 14 for forming of the rim base 4 and assuming the corresponding shape. In the FIG. 9 on the left, the mold parting surfaces (contact surfaces) 55 and 75 of the molding device 51 and of the auxiliary molding part 70 are still in contact with one another.

In the radially outside region it can be seen that in the region of the rim flange 6, the fiber layer 21 has been folded over, forming a folded-over and radially inwardly extending section 21b for reinforcing the rim flange 6.

Accordingly, the other of the molding devices 61 is also loaded with fiber layers 22, wherein the fiber layer 22 only extends over the flank contact surface 62. In this spot, a section 22b is likewise folded over in the region of the rim flange 7.

Thereafter, the auxiliary molding part 70 is carefully removed, and the other of the molding devices 61 is approached with the mold parting surface 65 to the mold parting surface 55 of the (selected) molding device 51, where they are attached to one another. Preferably, however, this is done after placing the circular device 80 (illustrated above in FIG. 9) onto the selected molding device 51 (see e.g. FIG. 10).

The annular unit 80a of the circular device 80 is provided with a ring cover 40a (here, of a silicone material) in the contact areas with the manufactured rim 1. The ring cover 40a may, in the peripheral direction, be configured as one piece or consist of a number of segments. The elastic ring cover 40a reliably provides for a sufficient compacting pressure.

A wall thickness 43 respectively thickness of the ring cover 40a is drawn in, approximately corresponding to the wall thickness 6a, 6b in the region of the rim flank 2, 3 or of the rim flange 6, 7. The wall thickness 43 may be only half of what is shown, or it may measure 2 mm, 3 mm, 4 mm, or 5 mm or 6 mm. What is substantial is, that a sufficient shape retention and reproducibility of the wall thicknesses and surface quality of the rims 1 is achieved. In general terms, the wall thickness 43 respectively thickness of a cover 40 lies in the range of the (minimum or maximum) wall thickness of the rim.

The wall thickness 43 lies, in particular, in the range between ⅛ (or 1/10) and 8 times (or 10 times) the minimum wall thickness 5a of the rim base 5 and/or it may preferably lie between 0.1 mm and 10 mm. In particularly preferred configurations, the thickness 43 lies between 1 mm and 6 mm and particularly preferably e.g. around 4 mm+/−2 mm.

FIGS. 10 and 11 show various process steps in manufacturing a different rim having a different layer pattern, wherein FIG. 10 shows the state after placing fiber layers 21 and 25 on the rim contact surface 52 and the rim base region 74 of an auxiliary molding part, and then removing the auxiliary molding part 70. The protruding section 21a will later reinforce the rim base 4 in the region of the rim flank 3.

Shown in broken lines (dashed) and vertically hatched is an (optional) mold cover 51b on the molding unit 51a. The mold cover 51b consists of a more elastic material than does the molding unit 51a and e.g. of a rubber-like material or a silicone or the like. This makes the mold cover 51b (somewhat) compressible, and it can preferably reduce its thickness respectively wall thickness during manufacture by a few percentage points. It is conceivable to provide such a mold cover 51b in the region of the rim flanges only. The mold cover 51b may be provided alternatively or supplementarily to the ring cover 40a.

FIG. 11 shows the next step in the manufacture of the rim 1 according to FIG. 10, wherein the other of the molding devices 61 has been placed on the circular device 80 with the ring cover 40a and the selected molding device 51. Now the entire layer pattern, which is exemplarily drawn in, can be seen.

Again, it is optionally possible for the molding device 61 to comprise a molding unit 61a and a mold cover 61b. Then the mold cover 61b provides the flank contact surface 62 overall or in the region of the rim flange.

It is also possible for the molding device 61 to comprise a molding unit 61a and a mold cover 61b, and for the circular device 80 to not comprise a ring cover 40a. At least in the region of the rim flanges, pressure is applied to the rim flange via the more elastic mold cover. The counterpressure is then applied directly by the annular unit 80a. Then, the circular device 80 may consist of the annular unit 80a only.

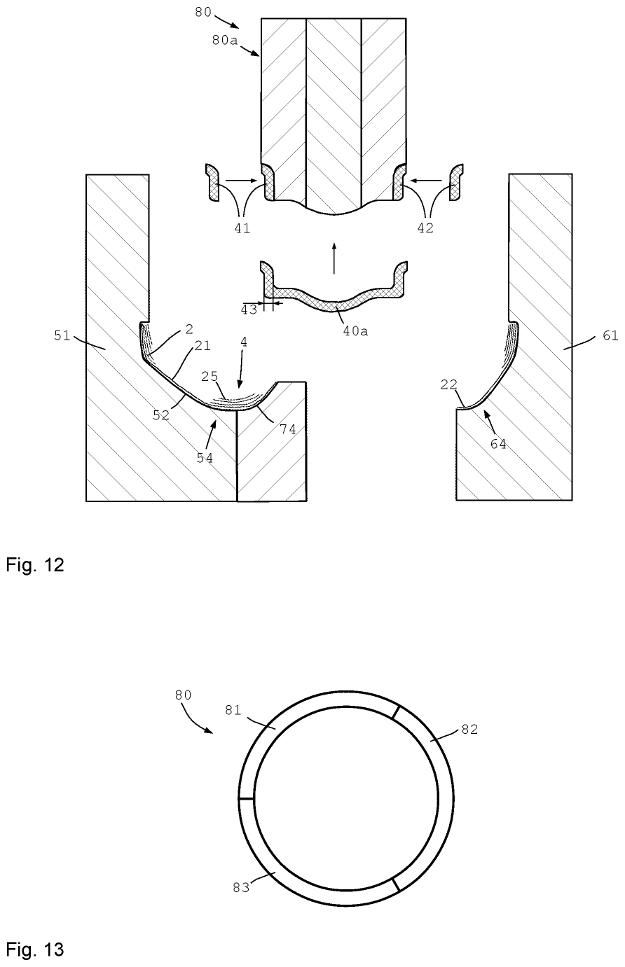

FIG. 12 shows an intermediate step in the manufacture of another rim 1, wherein on the left, the fiber layers 21 and 25 are illustrated, which have been placed on the selected molding device 51 and the rim base region 74 of the auxiliary molding part 70, while on the right in the FIG. 12 are shown the fiber layer 22 and the other fiber layers placed on the flank contact surface 62 and the rim base region 64.

The circular device 80 respectively the annular unit 80a may—depending on the structural layout—be provided with two separate ring covers 41, 42, which are mounted separately in the region of the rim flanges 6, 7. Or, a completely continuous ring cover 40a is mounted, which covers both of the rim flanges 6, 7. Optionally, the circular device 80 may be employed for different widths of manufactured rims by way of (locally) different wall thicknesses of the ring cover 40a. It is also possible to employ three or more separate ring covers, e.g. ring covers 41 and 42 for the rim flanges, and a ring cover 40a for the rim well.

FIG. 13 finally shows a schematic plan view of the circular device 80, where the three circumferentially disposed annular segments 81-83 can be seen.

In all the configurations, the various fiber layers may be placed on top of one another at various angles relative to one another. Thus, in one layer the fibers (warp fibers or weft fibers of a woven material) may be aligned at 30°, 60° or 45° to the peripheral direction of the finished rim. In a layer disposed on top thereof, the corresponding fibers may be aligned at another angle (e.g. another of the angles listed).

In the FIGS. 11 and 12, the wall thickness 43 respectively thickness 43 of a cover 40 (ring cover 40a or mold cover 51b or 61b) lies again in the range between 1/10 and 10 times the minimum wall thickness 5a of the rim base 5 and/or it may lie between 0.1 mm and 10 mm. Again, the thickness 43 lies, in particular, between 1 mm and 6 mm, e.g. around 4 mm+/−2 mm.

On the whole, the invention provides an advantageous method and an advantageous tool device, with which to manufacture rims 1 showing a reproducible, high quality. It is possible to provide a high surface quality of the outwardly visible surfaces, without complex refinishing work. An additional application of a varnish coat or varnish layer or the like is not required. This is made possible, among other things, by the fact that the outwardly visible layers of all the outside surfaces can be pressed immediately and directly on the corresponding mold surfaces of the tool device.

The manufacturing method is simple and thus avoids defects, and reduces the reject rate.

While a particular embodiment of the present tool device for manufacturing a rim, and rim, and use have been described herein, it will be appreciated by those skilled in the art that changes and modifications may be made thereto without departing from the invention in its broader aspects and as set forth in the following claims.

List of reference numerals:

| | |
|---|---|
| 1 | rim |
| 2, 3 | rim flank, rim side wall |
| 4 | rim base |
| 5 | rim well |
| 6, 7 | rim flange |
| 8, 9 | visible surface |
| 10 | hollow space |
| 11 | axis of symmetry |
| 14 | mold surface for forming the rim base |
| 15 | intersecting region |
| 16 | spoke hole |
| 20 | fibrous composite material |
| 21 | fiber layer, visible layer |
| 21a | reinforcement section |
| 21b | folded-over section |
| 22 | fiber layer, visible layer |
| 22b | folded-over section |
| 23 | fiber layer, visible layer |
| 24 | fiber layer |
| 25 | reinforcement layer |
| 29 | roving |
| 30 | prepreg |
| 32 | tube |
| 40 | cover |
| 40a | ring cover |
| 40b | material of 40a, 51b, 61b |
| 41 | pressing ring |
| 42 | pressing ring |
| 43 | thickness |
| 50 | tool device |
| 51 | molding device |
| 51a | molding unit |
| 51b | mold cover |
| 52 | flank contact surface |
| 54 | rim base region |
| 55 | mold parting surface |
| 56 | fastener |
| 57 | alignment unit |
| 61 | molding device |
| 61a | molding unit |
| 61b | mold cover |
| 62 | flank contact surface |
| 64 | rim base region |
| 65 | mold parting surface |
| 67 | alignment unit |
| 70 | auxiliary molding part |
| 74 | rim base region |
| 75 | mold parting surface |
| 77 | alignment unit |
| 80 | circular device, ring device |
| 80a | annular unit, core |
| 80b | material of 80a |
| 81-83 | annular segments |
| 84 | rim well contact surface |
| 85, 86 | annular segments |
| 87 | alignment unit |
| 90 | locking ring |
| 91 | clamping portion |
| 100 | bicycle |
| 101 | wheel, front wheel |
| 102 | wheel, rear wheel |
| 103 | frame |
| 104 | fork, suspension fork |
| 105 | rear wheel damper |
| 106 | handlebar |
| 107 | saddle |
| 109 | spoke |
| 110 | hub |
| 112 | pedal crank |

1. A tool device for manufacturing a rim for at least partially muscle-powered vehicles and in particular bicycles, having opposite rim flanks, a rim well and a rim base, and rim flanges configured on the rim flanks,
comprising: two molding devices and a circular device;
wherein the molding devices each comprise contact surfaces for forming at least part of a rim flank and the external visible surface of the rim flanges;
the circular device forms the rim well and the axially inwardly oriented surfaces of the rim flanges;
the circular device comprises an annular unit, and the molding devices each comprise a molding unit;
at least one of the units of an annular unit and molding units comprise a core of a less elastic material and at least one cover for attachment thereto, of a more elastic material;
and the thickness of the cover is between one eighth of the minimum wall thickness of the rim well of the rim manufactured and eight times the minimum wall thickness of the rim well of the rim manufactured.

2. The tool device according to claim 1, wherein the circular device comprises an annular unit of a less elastic material and at least one ring cover of a more elastic material,
and wherein the molding devices each comprise a molding unit of a less elastic material and at least one mold cover for attachment thereto of a more elastic material.

3. The tool device according to claim 1, wherein the thickness of the cover is between 0.16 mm and 6 mm.

4. The tool device according to claim 1, wherein the material of the ring cover and/or of the mold cover (51b, 61b) is configured more elastic than is the material of the annular unit and/or the molding devices.

5. The tool device according to claim 1, wherein in a radially inwardly region, the circular device comprises a contact surface for forming the rim well.

6. The tool device according to claim 5, wherein the circular device comprises two separate, axially spaced-apart pressing rings, which match the inner outline of the rim flange.

7. The tool device according to claim 1, wherein the ratio of the coefficient of elasticity of the materials of the annular unit and of the ring cover is higher than 2 or 5, and/or wherein the ratio of the coefficient of elasticity of the materials of the molding unit and of the mold cover is higher than 2 or 5.

8. The tool device according to claim 1, wherein the ring cover and the mold cover consist at least in part of a material taken from a group of materials comprising rubber-like materials and silicone materials.

9. The tool device according to claim 1, wherein the thickness of the ring cover and/or the mold cover is more than 0.5 mm and/or less than 5 mm.

10. The tool device according to claim 1, wherein the thickness of the ring cover is greater than half the axial width of the rim flange and/or less than three times the axial width of the rim flange.

11. The tool device according to claim 1, wherein for manufacturing two rims in different dimensions, the same annular unit may be employed by means of different ring covers.

12. A use of a tool device for manufacturing a rim for at least partially muscle-powered vehicles and in particular bicycles, wherein the tool device is configured according to claim 1.

13. A rim for at least partially muscle-powered vehicles and in particular bicycles with opposite rim flanks, a rim well and a rim base, where the rim flanks meet in the radially most inwardly point, manufactured from at least one fibrous composite material, using a tool device according to claim 1.

14. The rim according to claim 13, wherein the outer surface that is visible in operation as intended, is at least predominantly formed of the at least one fibrous composite material, and wherein the outer surface visible in operation as intended, does not, at least predominantly, comprise a varnish coat.
